(19) United States
(12) Patent Application Publication
(10) Pub. No.: US 2007/0101295 A1
(43) Pub. Date: May 3, 2007

(54) METHOD AND APPARATUS FOR DIAGNOSTIC IMAGING ASSISTANCE

(76) Inventors: Wei Ding, Beijing (CN); Yilun Shi, Beijing (CN)

Correspondence Address: PATRICK W. RASCHE (20459);ARMSTRONG TEASDALE LLP, ONE METROPOLITAN SQUARE, SUITE 2600, ST. LOUIS, MO, 63102-2740, US

(21) Appl. No.: 11/553,194

(22) Filed: Oct. 26, 2006

(30) Foreign Application Priority Data
Oct. 27, 2005 (CN) 200510118527.5

(51) Int. Cl. G06F 17/00; G06F 3/00; G06F 9/00

(52) U.S. Cl. 715/838

(57) ABSTRACT

The present invention facilitates the user to display an entire image of interest at the original size, a part thereof at an enlarged view, and the annotation information thereof for a listing display screen of a plurality of medical images. The present invention enables to display a listing of a plurality of shrunk medical images, and then at least either one of displaying the annotation information on the image of interest selected by the user on a pop-up floating window from within the plurality of medical images, displaying an entire image selected by the user from within the plurality of medical images at the original size on the pop-up floating window, and displaying the partial image selected by the user from within the plurality of medical images at the original size on the pop-up floating window.

### BACKGROUND OF THE INVENTION

The present invention is related to a method and an apparatus for image diagnosis assistance, and more specifically to a method and an apparatus for assistance of diagnostic medical imaging.

In diagnostic medical imaging assistance systems, images taken with such medical imaging apparatuses as X-ray CT (computed tomography) apparatuses and MRI (magnetic resonance imaging) apparatuses are stored in a server as image files and displayed on a display of a workstation for the purpose of diagnosis (for example, see patent reference 1).

[PATENT REFERENCE JP-A-H08(1996)-161463, Page 3, FIGS. 1 to 4

### SUMMARY OF THE INVENTION

X-ray CT apparatuses of the type referred to as VCT or MDCT take dozens of tomographic images for each scan. Such a large number of images may be displayed on a display of a workstation in a matrix, such that an image is shrunk to fit to a square of grid of the display.

Although the browsability of images may be improved in this type of display, diagnosis will become difficult because the size of an image is reduced. For an image of interest, the entire image must be redisplayed at the original size or partly enlarged by performing some operation and at the same time the property information such as imaging condition and image reconstruction condition may need to be displayed.

The problem to be solved by the present invention is to achieve a method and an apparatus for diagnostic medical imaging assistance, in which a user is allowed to display an image of interest at the original size, enlarge part thereof, and display the property information from within the browsing display of a plurality of images.

The present invention in one aspect for solving the problem mentioned above provides a method for diagnostic medical imaging assistance, comprising the steps of: displaying a listing of a plurality of shrunk medical images; and enabling at least one of displaying, on a pop-up floating window, the annotation information with respect to the image selected by a user from within the plurality of shrunk medical images, displaying, on the pop-up floating window, an entire image at the original size of that selected by the user from within the plurality of shrunk medical images, and displaying, on the pop-up floating window, a partial image at the original size of that selected by the user from within the plurality of shrunk medical images.

The present invention in another aspect for solving the problem mentioned above provides an apparatus for diagnostic medical imaging assistance, comprising: a means for displaying a listing of a plurality of shrunk medical images; a means for displaying, on a pop-up window, the annotation information with respect to the image selected by a user from within the plurality of shrunk medical images; a means for displaying, on the pop-up floating window, an entire image at the original size of that selected by the user from within the plurality of shrunk medical images; and a means for displaying, on the pop-up floating window, a partial image at the original size of that selected by the user from within the plurality of shrunk medical images.

It is preferable to perform measurement or adjustment specified by the user of at least either one of the entire image at the original size or the partial image at the original size in order to conduct an appropriate diagnosis.

It is preferable for the pop-up floating window of the entire image at the original size to display the positional coordinate of a pointer in order to accurately recognize the position of the pointer.

It is preferable for the pop-up floating window of the partial image at the original size to be capable of being resized in order to improve the convenience.

It is preferable for the display screen displaying the pop-up floating window to be capable of being stored in order to facilitate the image reproduction.

It is preferable for the pop-up floating window to be erasable in order to solve the overlap on the listing display.

In accordance with the present invention in the aspects described above, the present invention allows a plurality of shrunk medical images to be displayed as listing, and enables at least one of displaying the annotation information with respect to the image selected by the user from within the plurality of shrunk medical images on the pop-up floating window, displaying the entire image at the original size of that selected by the user from within the plurality of shrunk medical images on the pop-up floating window, and displaying a partial image at the original size of that selected by the user from within the plurality of shrunk medical images on the pop-up floating window. The user is encouraged to display the image of interest at the original size, display a part of an image in magnification, and display the annotation information in the listing display screen of a plurality of images.

The best mode for carrying out the invention will be described in greater details with reference to the accompanying drawings herein below. It is to be noted here that the present invention should not be considered to be limited to the best mode for carrying out the invention described herein. The arrangement of a diagnostic medical imaging assistance apparatus is shown in a schematic block diagram of FIG. 1. The apparatus is an exemplary embodiment of the best mode for carrying out the invention. The arrangement of the apparatus illustrates an exemplary embodiment of the best mode for carrying out the invention of a diagnostic medical imaging assistance apparatus. The operation of the apparatus illustrates an exemplary embodiment of the best mode for carrying out the invention of a diagnostic medical imaging assistance apparatus.

As shown in FIG. 1, the inventive apparatus includes a data processing unit 10, a display unit 20, an operating console unit 30, a storage unit 40, and an input/output unit 50. The data processing unit 10 is the center of the apparatus, which is constituted by a computer. The display unit 20 is constituted by a graphic display. The operating console unit 30 is constituted by a keyboard equipped with a pointing device.

The data processing unit 10 displays medical images on the display unit 20 based on the interactive operation by the user through the display unit 20 and the operating console unit 30. The user is allowed to make diagnosis based on the medical images displayed on the display unit 20.

The medical images are captured from the outside through the input/output unit 50 and stored in the storage unit 40. Some examples of external apparatuses are medical imaging devices such as X-ray CT apparatuses and MRI apparatuses, or medical image servers. The inventive apparatus may be a part of such medical imaging apparatuses or medical imaging servers. In this case the input/output unit 50 is not necessarily required.

Diagnostic imaging using the inventive apparatus will be described now. FIG. 2 shows a process of diagnostic imaging. As shown in FIG. 2, a listing of a plurality of images is displayed in step 200. The listing of the plurality of images may be for example on the screen shot as shown in FIG. 3.

As shown in FIG. 3, the display screen is split into grids, and an image is displayed in each grid. Each grid constitutes the display frame of medical image, while at the same time constituting a user interface which is clickable by the pointing device. The data processing unit 10 and the display unit 20 involving such display is an exemplary embodiment of a “means for displaying a listing of a plurality of shrunk medical images.”

Although in the drawings a matrix of 3 by 5 grids is shown, any appropriate size and layout is possible for example 2 by 2, 3 by 3, or 3 by 4. X-ray CT tomographic images are shown in the drawings as medical imaging, medical images taken by any other modalities including such as MRI apparatuses are equally allowed.

Left hand side of the display screen constitutes a user interface. The user interface is a collection of plurality of operation buttons clickable by the pointing device. Among those buttons, two buttons in the third row from beneath are “image info” and “detail” buttons, and the left button in the bottom raw is “save screen” button.

For each medical image in the grid, image information, entire image at the original size, and partial image at the original size can be displayed. Whether the display of such information and image is required or not is user selectable in steps 211, 231, and 251.

In step 211, when the user decides to display the image information of the desired image, the user selects (clicks) the image then clicks on the Image Info button in step 213. By doing this the image information will be displayed on a pop-up floating window in step 215.

FIG. 4 shows an example of image information display using a pop-up floating window. As shown in FIG. 4, the pop-up floating window appears overlapping on the screen near the left top corner to display image information therewithin. The image information contains the annotation with respect to the selected medical image.

The annotation information includes for example SFOV, DFOV, Kernel, kV, Morpheme analysis, Type, Auto mA, Thickness, Pitch, Scan Time and the like. SFOV means scan FOV (scan field of view). DFOV means display FOV (display field of view). Kernel indicates the kernel for image reconstruction, kV designates the tube voltage, and mA designates the tube current. Type designates the scan type. Auto mA designates the tube current optimization control. Thickness designates the slice thickness. Pitch designates the pitch of helical scan. Scan Time designates the scanning time.

The data processing unit 10 and the display unit 20, which involve the screen display as have been described above, constitutes an exemplary embodiment of a “means for displaying the annotation information on a pop-up floating window.”

The user may refer to the annotation information of the selected image based on the display. Once the reference is completed, the user closes the pop-up floating window in step 221. By doing this the overlap by a pop-up floating window on the listing display is resolved and the display image goes back to the state shown in FIG. 3.

In step 231, if the user determines that the display of entire image at the original size for a desired image is needed, then the user double-clicks on the desired image in step 233. Then the entire image at the original size will be displayed on a pop-up floating window in step 235.

FIG. 5 shows an example of entire image display at the original size on a pop-up floating window. As shown in FIG. 5, the pop-up floating window appears overlapping on the middle of the display screen to display the entire image at the original size. The user is allowed to diagnose based on this display. Since the displayed image is at the original size, precise and detailed diagnosis is achievable.

The data processing unit 10 and the display unit 20 involving such display are an exemplary embodiment of a “means for displaying an entire image at the original size on a pop-up floating window” in accordance with the present invention.

When moving the pointer onto the image of original size, the positional coordinate of the pointer will be displayed. The user thereby may recognize the accurate position of the pointer. The positional coordinate of the pointer is identified in millimeter or centimeter.

In step 237 the image is measured or adjusted. The measurement may be for example the CT number measurement on the ROI and the distance measurement, the adjustment may be the window level and window width adjustment. These measurement and adjustment are performed to facilitate an appropriate diagnosis. The measurement and adjustment may be performed as required, and may be omitted if not needed.

Once the measurement or adjustment is completed, then the user clicks on the “Save Screen” button in step 239. This action saves the measured or adjusted image. In this manner the saved display screen can be reproduced later.

The data processing unit 10 and the display unit 20 involving such measurement and adjustment are an exemplary embodiment of a “means for performing the measurement or adjustment specified by the user” in accordance with the present invention. The display screen may be saved as required and may be omitted if not needed.

Thereafter, in step 241, the user closes the pop-up floating window. By doing this the overlap by a pop-up floating window on the listing display is resolved and the display image goes back to the state shown in FIG. 3.

In step 251, if the user determines that the display of partial imaging at the original size for a desired image is needed, then the user specifies (clicks) the desired image, and in step 253 clicks on the Detail button. Thereby the partial image at the original size will be displayed on a pop-up floating window in step 255.

The dimension of a pop-up floating window can be predefined by the user. The configurable window sizes includes for example 32 by 32, 64 by 64, 128 by 128 in the matrix size. This will improve the convenience.

FIG. 6 shows an example of partial image display at the original size in a pop-up floating window. As shown in FIG. 6 the pop-up floating window appears overlapping on the middle of the display screen to display the partial image at the original size. The user is allowed to diagnose based on this display. Since the displayed partial image is at the original size, precise and detailed diagnosis at the region of interest is achievable.

The data processing unit 10 and the display unit 20, which involve the display of such display, constitute an exemplary embodiment of a “means for displaying a partial image at the original size on a pop-up floating window” in accordance with the present invention.

In step 257 the image is measured or adjusted. The measurement may be for example the CT number measurement or the distance measurement, and the adjustment may be the window level adjustment and window width adjustment. The data processing unit 10 and the display unit 20, which involve the measurement or adjustment, constitutes a “means for performing the measurement or adjustment specified by the user” in accordance with the present invention. The measurement and adjustment may be performed as required, and may be omitted if not needed.

Once the measurement or adjustment is completed, then the user clicks on the “Save Screen” button in step 259. This action saves the measured or adjusted image. The display screen may be saved as required and may be omitted if not needed.

Thereafter, in step 261, the user closes the pop-up floating window. By doing this the overlap by a pop-up floating window on the listing display is resolved and the display image goes back to the state shown in FIG. 3.

By the operation as have been described above on a desired image from within a plurality of listed images, the image information, an entire image at the original size, or a partial image at the original size can be displayed. The display is responsive to the click by the pointing device and overlapped on the matrix display of a plurality of medical imaging on a pop-up floating window, yielding a higher operability. The diagnostic imaging of higher efficiency is allowed thereby.

### BRIEF DESCRIPTION OF DRAWINGS

FIG. 1 is the overview of an exemplary diagnostic imaging assistance apparatus in accordance with the best mode for carrying out the invention;

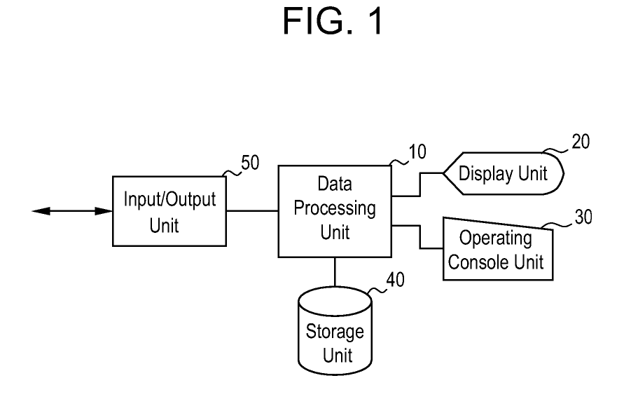

FIG. 2 is an exemplary process of diagnostic imaging;

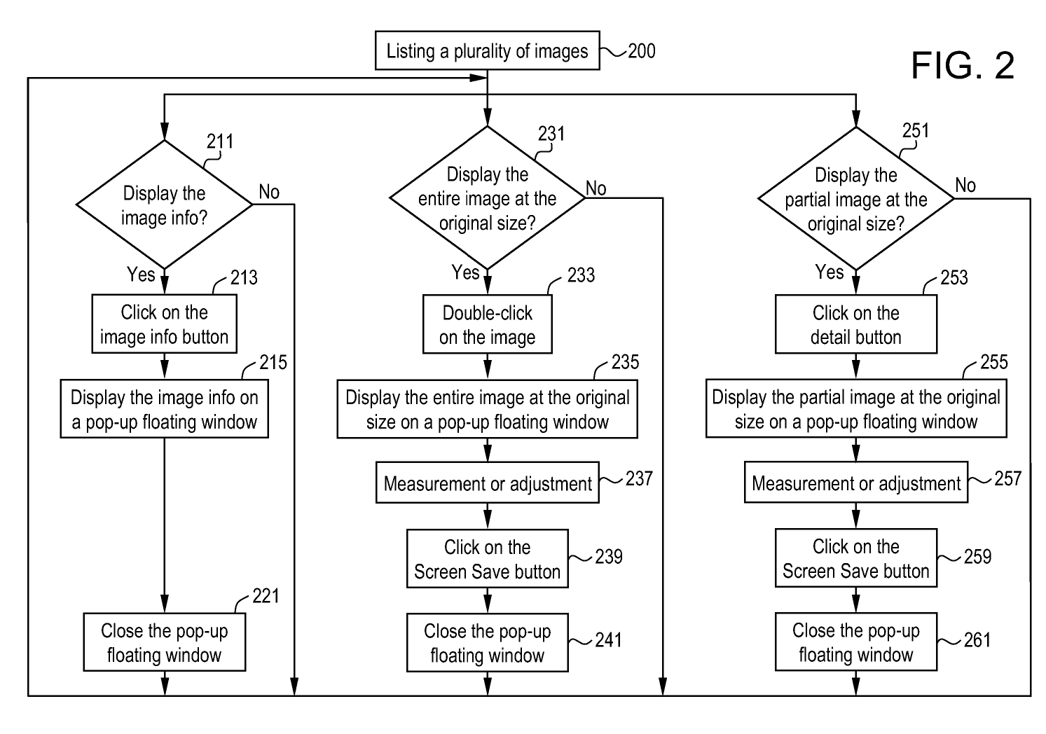

FIG. 3 is an exemplary screen displayed on a display at the time of diagnostic imaging shown in a gray scale photograph;

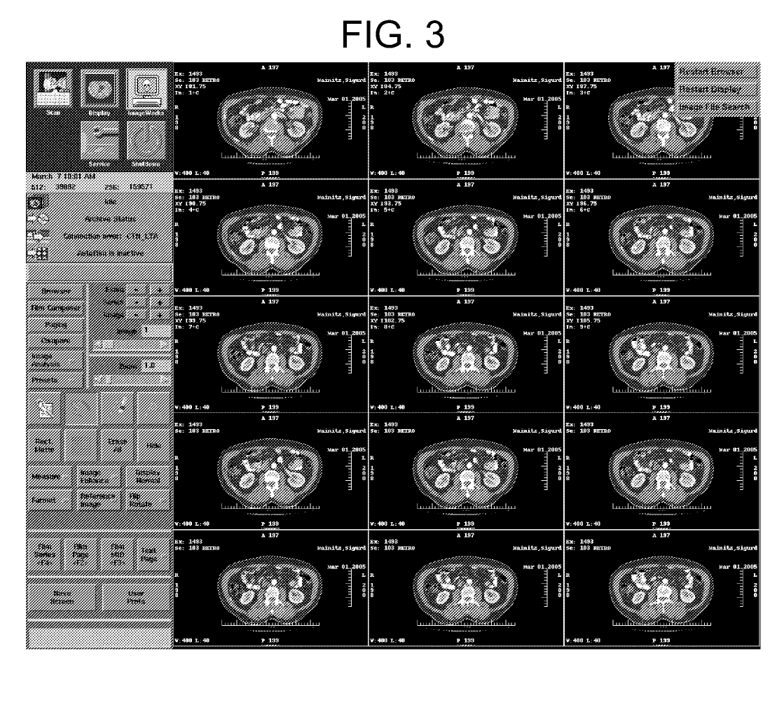

FIG. 4 is an exemplary screen displayed on a display at the time of diagnostic imaging shown in a gray scale photograph;

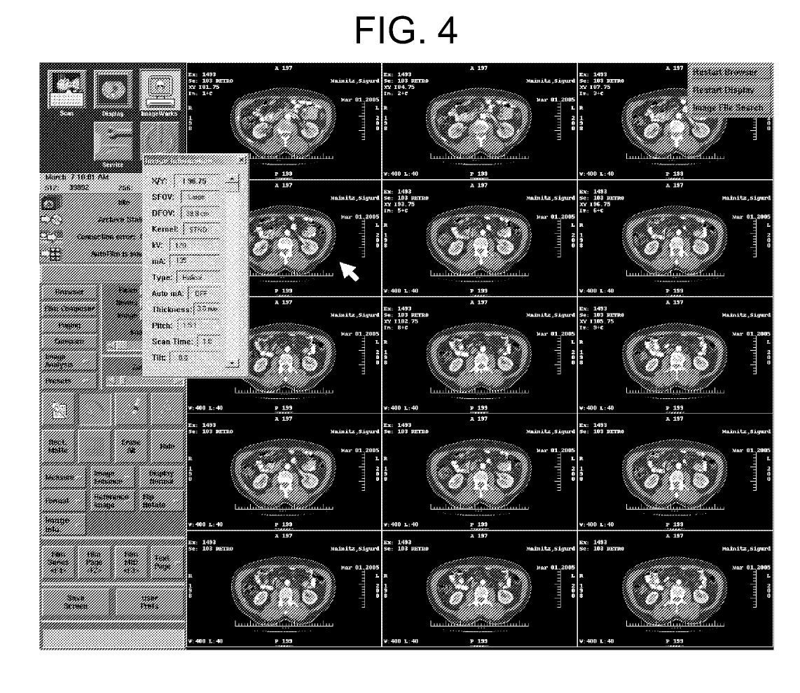

FIG. 5 is an exemplary screen displayed on a display at the time of diagnostic imaging shown in a gray scale photograph; and

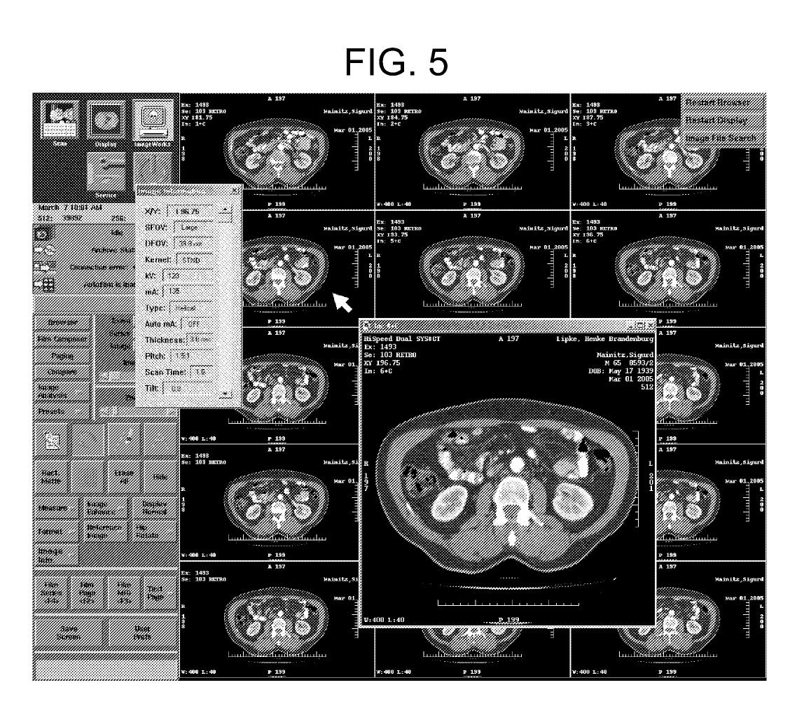

FIG. 6 is an exemplary screen displayed on a display at the time of diagnostic imaging shown in a gray scale photograph.

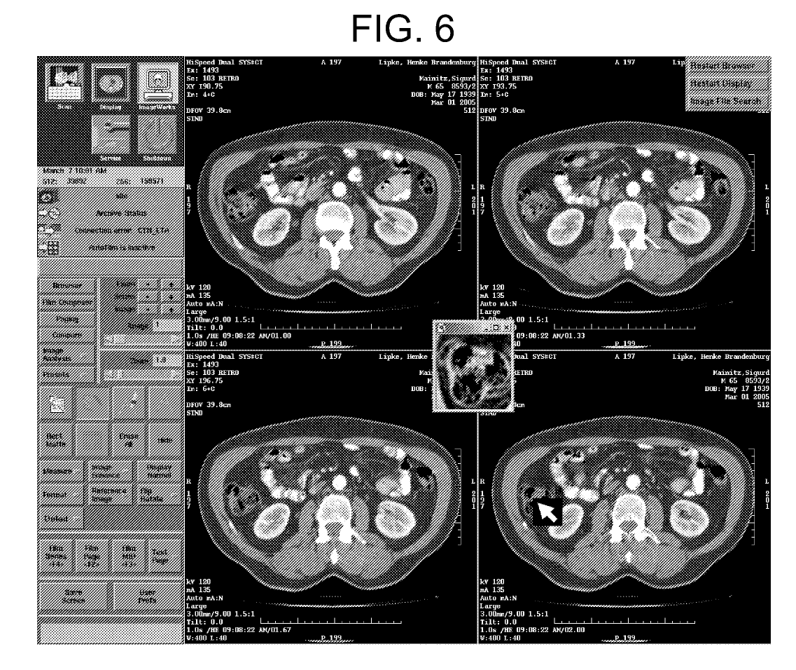

### REFERENCE NUMERALS

10 data processing unit
20 display unit
30 operating console unit
40 storage unit
50 input/output unit

1. A method for diagnostic medical imaging assistance, comprising the steps of:
displaying a listing of a plurality of shrunk medical images; and
enabling at least one of
displaying, on a pop-up floating window, the annotation information with respect to the image selected by a user from within said plurality of shrunk medical images,
displaying, on the pop-up floating window, an entire image at the original size of that selected by said user from within said plurality of shrunk medical images, and
displaying, on the pop-up floating window, a partial image at the original size of that selected by said user from within said plurality of shrunk medical images.

2. A method for diagnostic medical imaging assistance according to claim 1, wherein:
measurement or adjustment specified by the user is performed on at least either one of said entire image at the original size or said partial image at the original size.

3. A method for diagnostic medical imaging assistance according to claim 1, wherein:
the pop-up floating window of said entire image at the original size indicates the positional coordinates of the pointer.

4. A method for diagnostic medical imaging assistance according to claim 1, wherein:
the size of the pop-up floating window of said partial image at the original size is user-adjustable.

5. A method for diagnostic medical imaging assistance according to claim 1, wherein:
the display screen that displays said pop-up floating window is capable of being stored.

6. A method for diagnostic medical imaging assistance according to claim 1, wherein:
said pop-up floating window is erasable.

7. An apparatus for diagnostic medical imaging assistance, comprising:
a means for displaying a listing of a plurality of shrunk medical images;
a means for displaying, on a pop-up window, the annotation information with respect to the image selected by a user from within said plurality of shrunk medical images;
a means for displaying, on the pop-up floating window, an entire image at the original size of that selected by said user from within said plurality of shrunk medical images; and
a means for displaying, on the pop-up floating window, a partial image at the original size of that selected by said user from within said plurality of shrunk medical images.

8. An apparatus for diagnostic medical imaging assistance according to claim 7, further comprising:
a means for performing a measurement or adjustment specified by the user of at least one of said entire image at the original size and said partial image at the original size.

9. An apparatus for diagnostic medical imaging assistance according to claim 7, wherein:
the pop-up floating window of said entire image at the original size displays the positional coordinates of the pointer.

10. An apparatus for diagnostic medical imaging assistance according to claim 7, wherein:
the size of the pop-up floating window of said partial image at the original size is user-adjustable.

11. An apparatus for diagnostic medical imaging assistance according to claim 7, wherein:
the display screen that displays said pop-up floating window is capable of being stored.

12. An apparatus for diagnostic medical imaging assistance according to claim 7, wherein:
said pop-up floating window is erasable,
